(19) United States
(12) Patent Application Publication
(10) Pub. No.: US 2016/0079684 A1
(43) Pub. Date: Mar. 17, 2016

(54) Connection Structure for Terminal Metal Fittings

(71) Applicant: Yazaki Corporation, Tokyo (JP)

(72) Inventors: Yukinari Naganishi, Makinohara-shi (JP); Masashi Tsukamoto, Makinohara-shi (JP); Atsushi Nakata, Makinohara-shi (JP)

(73) Assignee: Yazaki Corporation, Tokyo (JP)

(21) Appl. No.: 14/945,490

(22) Filed: Nov. 19, 2015

Related U.S. Application Data
(63) Continuation of application No. PCT/JP2014/063375, filed on May 20, 2014.

(30) Foreign Application Priority Data
May 21, 2013 (JP) 2013-107071

(51) Int. Cl. H01R 4/16

(52) U.S. Cl. CPC H01R 4/16

(57) ABSTRACT

There are provided a first ground terminal metal fitting to which a plurality of first ground electric wires are connected; and a second ground terminal metal fitting to which a plurality of second ground electric wires are connected. One of the first ground terminal metal fitting and the second ground terminal metal fitting is connected and fixed to a mating terminal connection portion or a ground portion exclusively in accordance with the number of the first electric wires and the number of the second electric wires, or the first ground terminal metal fitting and the second ground terminal metal fitting are combined with each other and then connected and fixed to the mating terminal connection portion or the ground portion.

### CROSS REFERENCE TO RELATED APPLICATIONS

This application is a continuation of PCT application No. PCT/JP2014/063375, which was filed on May 20, 2014 based on Japanese Patent Application (No. P2013-107071) filed on May 21, 2013, the contents of which are incorporated herein by reference.

### BACKGROUND OF THE INVENTION

1. Field of the Invention

The present invention relates to a connection structure for terminal metal fittings.

2. Description of the Related Art

FIG. 9 and FIG. 10 show a ground terminal metal fitting disclosed in JP-A-2012-190749.

The ground terminal metal fitting 100 is a press-molded article of a metal plate, which is used for connecting a ground electric wire (ground wire) of an in-vehicle circuit to a ground surface of a vehicle body etc. The ground terminal metal fitting 100 includes a terminal body 110 and an electric wire connection portion 120. The terminal body 110 is shaped like a flat plate. The electric wire connection portion 120 extends from the terminal body 110.

The terminal body 110 is fixed to the ground surface by a bolt (not shown) which is inserted through a circular mounting hole 111 provided in the center of the terminal body 110. An outer circumference of the terminal body 110 in JP-A-2012-190749 is shaped like a circle concentric to the mounting hole 111. A pair of to-be-held pieces 131 and a pair of body holding portions 132 are provided in the outer circumference of the terminal body 110.

The to-be-held pieces 131 and the body holding portions 132 are units by which ground terminal metal fittings 100 can be coupled to each other in a overlapped state.

The pair of to-be-held pieces 131 are provided in positions opposite to each other with respect to the mounting hole 111, so that the pair of to-be-held pieces 131 can protrude outward in a radial direction.

The pair of body holding portions 132 are provided in positions opposite to each other with respect to the mounting hole 111. In addition, the pair of body holding portions 132 are provided in the outer circumference of the terminal body 110 so as to be circumferentially adjacent to the pair of to-be-held pieces 131.

The body holding portions 132 are parts which hold to-be-held pieces 131 provided in another ground terminal metal fitting 100 respectively. In each of the body holding portions 132, a protrusive piece extending radially outward from the outer circumference of the terminal body 110 is bent toward the mounting hole 111 side to thereby form a holding groove 132a into which the to-be-held piece 131 can be inserted.

The electric wire connection portion 120 includes a fixation caulking piece 121 and a conductor crimping caulking piece 122. The fixation caulking piece 121 caulks a ground electric with its sheath wire so as to fix the ground electric wire. The conductor crimping caulking piece 122 caulks a conductor of the ground electric wire directly so as to connect the conductor of the ground electric wire to the ground terminal metal fitting 100 electrically conductively.

That is, the electric wire connection portion 120 in the ground terminal metal fitting 100 according to JP-A-2012-190749 has a structure for crimping and connecting the ground electric wire.

Ground terminal metal fittings 100 in JP-A-2012-190749 can be coupled to each other in a overlapped state in a procedure which will be described as follows. First, terminal bodies 110 of the two ground terminal metal fittings 100 are overlapped on each other while positions of mounting holes 111 are aligned with each other. Next, as shown in FIG. 10, the ground terminal metal fittings 100 are rotated relatively to each other in a direction of an arrow R1 so that to-be-held pieces 131 of the upper ground terminal metal fitting 100 are held by body holding portions 132 of the lower ground terminal metal fitting 100. In this manner, coupling of the ground terminal metal fittings 100 is completed.

To decouple the coupled ground terminal metal fittings 100 from each other, the ground terminal metal fittings 100 are rotated relatively to each other in a direction of an arrow R2 in FIG. 10, which is opposite to a direction applied at the coupling time.

In the case of the ground terminal metal fittings 100 according to JP-A-2012-190749, a plurality of ground terminal metal fittings 100 are coupled to one another in a overlapped state as shown in FIG. 10. Thus, it is possible to deal with an increase of the number of ground electric wires.

In the case of the ground terminal metal fittings 100 according to JP-A-2012-190749, the ground terminal metal fittings 100 are coupled to one another, for example, in order to deal with an increase of the number of ground electric wires to be connected. When the ground terminal metal fittings 100 are in use, the electric wire connection portions 120 take a form to be opened at an angle θ from one another around the mounting hole 111, as shown in FIG. 10. Therefore, ground electric wires connected to the ground terminal metal fittings 100 are spread at the angle θ from one another so that there is a problem that it may be difficult to route the ground electric wires compactly.

### SUMMARY OF THE INVENTION

Therefore, in order to solve the foregoing problem, an object of the invention is to provide a connection structure for terminal metal fittings, which can deal with an increase of the number of electric wires and which can route the electric wires compactly.

The aforementioned object of the invention can be achieved by the following configurations.
(1) A connection structure for terminal metal fittings, including:

a first terminal metal fitting to which a plurality of first electric wires are connected; and

a second terminal metal fitting to which a plurality of second electric wires are connected,

wherein one of the first terminal metal fitting and the second terminal metal fitting is enable a connection and fixation to a mating terminal connection portion or a ground portion exclusively in accordance with the number of the first electric wires and the number of the second electric wires;

wherein the first terminal metal fitting and the second terminal metal fitting are combined with each other and then connected and fixed to the mating terminal connection portion or the ground portion.
(2) The connection structure for the terminal metal fittings according to the aforementioned configuration (1), wherein the first electric wires and the second electric wires are consist of electric wires of copper (including a copper alloy), electric wires of aluminum (including an aluminum alloy), or a mixture of electric wires of copper (including a copper alloy) and electric wires of aluminum (including an aluminum alloy).
(3) The connection structure for the terminal metal fittings according to the aforementioned configuration (1), wherein one of the first electric wires and the second electric wires are consist of electric wires of copper (including a copper alloy); and

wherein the other of the first electric wires and the second electric wires are consist of electric wires of aluminum (including an aluminum alloy) or a mixture of electric wires of copper (including a copper alloy) and electric wires of aluminum (including an aluminum alloy).
(4) The connection structure for the terminal metal fittings according to any of the aforementioned configurations (1) to (3), wherein the first electric wires and the second electric wires include drain wires for shield electric wires.
(5) The connection structure for the terminal metal fittings according to any of the aforementioned configurations (1) to (4), wherein the first terminal metal fitting includes a first terminal body having a flat portion;

wherein the second terminal metal fitting includes a second terminal body having a flat portion; and

wherein the first terminal metal fitting and the second terminal metal fitting include a combinational structure configured to integrate the first and second terminal metal fittings each other.
(6) The connection structure for terminal metal fittings according to the aforementioned configuration (5), wherein the first terminal metal fitting includes:

the first terminal body which is shaped like a flat plate with a mounting hole; and

a first electric wire connection portion to which the plurality of first electric wires are connected;

wherein the first terminal body has two sides opposite to each other with respect to the mounting hole;

wherein the first electric wire connection portion extends in an opposing direction of the two sides from an outer edge portion of the first terminal body located distantly from the mounting hole in a direction perpendicular to the opposing direction of the two sides, and supports the first electric wires in the opposing direction of the two sides;

wherein the second terminal metal fitting includes:

the second terminal body which is formed into a flat plate shape having substantially the same dimensions and shape as the first terminal body so that the second terminal body can be overlapped on the first terminal body;

a pair of body holding pieces which are provided consecutively to two sides of the second terminal body corresponding to the two sides of the first terminal body so that when an insertion operation is performed in the direction perpendicular to the opposing direction of the two sides of the first terminal body to put the first terminal body on top of the second terminal body, the body holding portions is enable to hold the two sides of the first terminal body to thereby make a coupling state between the first terminal body and the second terminal body; and

a second electric wire connection portion to which the plurality of second electric wires are connected;

wherein the second electric wire connection portion is provided in an outer edge portion of the second terminal body located on an opposite side to the first electric wire connection portion of the first terminal metal fitting with respect to the mounting hole, and supports the plurality of second electric wires in parallel with an electric wire leading-out direction in the first terminal metal fitting; and

wherein the first terminal metal fitting and the second terminal metal fitting are overlapped on each other and then connected and fixed to the mating terminal connection portion or the ground portion.
(7) The connection structure for terminal metal fittings according to the aforementioned configuration (5) or (6), wherein a rotation stopping piece is provided on one of the first terminal body and the second terminal body, the rotation stopping piece being engaged with a step in the periphery of the ground portion to restrict the two terminal bodies from rotating relatively to the ground portion.

According to the aforementioned configuration (1), the first and second terminal metal fittings can be used as ground terminal metal fittings. In this case, it is unnecessary to use a joint (also including a joint connector) to connect ground electric wires on an upstream side of a circuit. Thus, it is possible to directly ground the electric wires through ground terminals and it is possible to improve and stabilize the grounding performance. In addition, it is possible to increase the number of terminals in accordance with the number of circuits and combine the terminals. Accordingly, it is possible to ground a large number of ground electric wires directly at a small number of places.

In addition, ground electric wires to be connected directly to an accessory are connected to an electric wire connection portion. That is, ground electric wires from an accessory are grounded directly to a vehicle body etc. without going via a joint (also including a joint connector). Accordingly, it is possible to prevent noise caused by grounding the ground electric wires via a joint (also including a joint connector).

Incidentally, when ground electric wires are manufactured, the ground electric wires may be divided and manufactured in consideration of assemblability etc. Then, the ground electric wires may be connected and integrated with one another by a connector for connecting the ground electric wires simply. In the invention, the ground electric wires directly connected to the accessory may include such a plurality of ground electric wires which are connected by a connector to connect the ground terminal metal fittings and the accessory to each other.

In addition, according to the aforementioned configuration (1), the first and second terminal metal fittings may be connected to the mating terminal connection portion belonging to a power supply etc.

According to the aforementioned configuration (2), it is possible to route the electric wires desirably in accordance with the kinds of electric wires used as the electric wires.

According to the aforementioned configuration (3), only the electric wires of copper (including a copper alloy) are connected to one terminal metal fitting. Accordingly, it is possible to simplify equipment or a work for performing connection between the terminals and the electric wires (for example, by ultrasonic bonding, a bonder (thermal welding), crimping, etc.). This is because it will go well as long as the electric wires of copper are taken into consideration in any setting value of the equipment etc. or during any work of connection. Only the other electric wires contain aluminum. Accordingly, it will go well as long as anticorrosion treatment etc. is applied to only connection portions between the other electric wires and the terminal. The anticorrosion treatment etc. does not have to be performed on the electric wires of copper.

According to the aforementioned configuration (4), the drain wires connected to shield layers of the shield electric wires can be also grounded in the same manner.

According to the aforementioned configuration (5), the two terminal bodies include the flat portions respectively. Accordingly, it is possible to stabilize connection between the two terminals. In addition, even in the case where each of the terminal metal fittings is used for grounding exclusively, it is possible to stabilize connection of the terminal metal fitting to the ground surface.

According to the aforementioned configuration (6), the first terminal body of the first terminal metal fitting is put on top of the second terminal body of the second terminal metal fitting by an insertion operation performed in the direction perpendicular to the opposing direction of the two sides. In this manner, the opposite two sides of the first terminal body of the first terminal metal fitting are held by the pair of body holding portions on the second terminal body of the second terminal metal fitting. Accordingly, the first terminal metal fitting and the second terminal metal fitting are coupled to each other in a state in which the first terminal body of the first terminal metal fitting is overlapped on the second terminal body of the second terminal metal fitting.

That is, the second terminal metal fitting can be coupled to the first terminal metal fitting easily by an insertion operation performed from the side of the first terminal metal fitting.

When the first terminal metal fitting and the second terminal metal fitting are combined with each other, it is possible to increase the number of electric wires which can be connected. It is therefore possible to deal with an increase of the number of the electric wires easily.

In addition, the first electric wires connected to the first terminal metal fitting and the second electric wires connected to the second terminal metal fitting are led out in parallel with each other from the terminal metal fittings respectively. Therefore, it is possible to bundle and route a large number of electric wires easily and it is also possible to route the large number of electric wires compactly.

In addition, according to the aforementioned configuration (6), the terminal body of the first terminal metal fitting and the second terminal body of the second terminal metal fitting which are overlapped on each other are coupled to each other when the opposite two sides are held. Accordingly, simultaneously with the coupling, the first terminal metal fitting and the second terminal metal fitting are restricted from being rotating relatively to each other. Therefore, a special structure for restricting the terminal metal fittings from rotating relatively to each other is not necessarily provided in the first terminal metal fitting or the second terminal metal fitting. Thus, it is also possible to simplify the structures of the respective terminal metal fittings.

According to the aforementioned configuration (7), the first terminal metal fitting which has been coupled to the second terminal metal fitting is fastened to the ground surface with a bolt. In this manner, the rotation stopping piece provided in any of the terminal metal fittings restricts the terminal metal fittings from rotating relatively to the ground surface. Thus, it is unnecessary to press the terminal metal fittings to prevent the terminal metal fittings from rotating relatively to the ground surface during a bolt fastening work. Therefore, it is possible to easily perform a work for fixing the terminal metal fittings to the ground surface.

In addition, the same rule is also applied to the case where the terminal metal fitting having the rotation stopping piece is used exclusively.

### Advantageous Effects of Invention

According to the connection structure for ground terminal metal fittings according to the invention, the first and second terminal metal fittings are combined with each other. In this manner, it is possible to deal with an increase of the number of electric wires easily and it is possible to route the electric wires compactly.

The invention has been described above briefly. Further, when a mode (hereinafter referred to as “embodiment”) for carrying out the invention which will be described below is read through with reference to the accompanying drawings, details of the invention can be made further clear.

### BRIEF DESCRIPTION OF THE DRAWINGS

FIG. 1 is a perspective view of a decoupling state of a first embodiment of a connection structure for terminal metal fittings according to the invention.

FIG. 2 is a perspective view of a coupling state between a first ground terminal metal fitting and a second ground terminal metal fitting shown in FIG. 1.

FIG. 3 is a perspective view of a decoupling state of a second embodiment of the connection structure for terminal metal fittings according to the invention.

FIG. 4 is a perspective view of a coupling state between a first ground terminal metal fitting and a second ground terminal metal fitting shown in FIG. 3.

FIG. 5 is a perspective view of a decoupling state of a third embodiment of the connection structure for terminal metal fittings according to the invention.

FIG. 6 is a perspective view of a coupling state between a first ground terminal metal fitting and a second ground terminal metal fitting shown in FIG. 5.

FIG. 7 is a perspective view of a decoupling state of a fourth embodiment of the connection structure for terminal metal fittings according to the invention.

FIG. 8 is a perspective view of a coupling state between a first ground terminal metal fitting and a second ground terminal metal fitting shown in FIG. 7.

FIG. 9 is a plan view of a ground terminal metal fitting according to the background art.

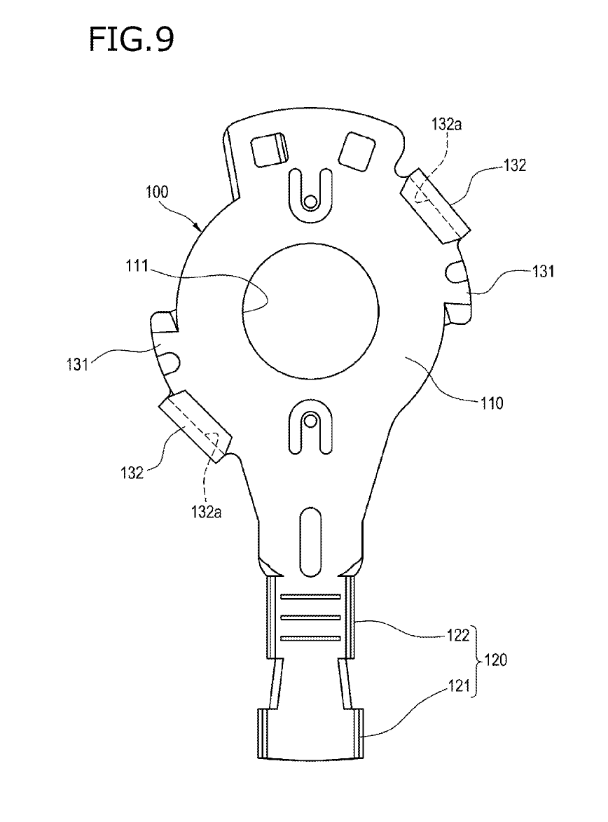

FIG. 10 is an explanatory view of a state in which ground terminal metal fittings shown in FIG. 9 are coupled to each other.

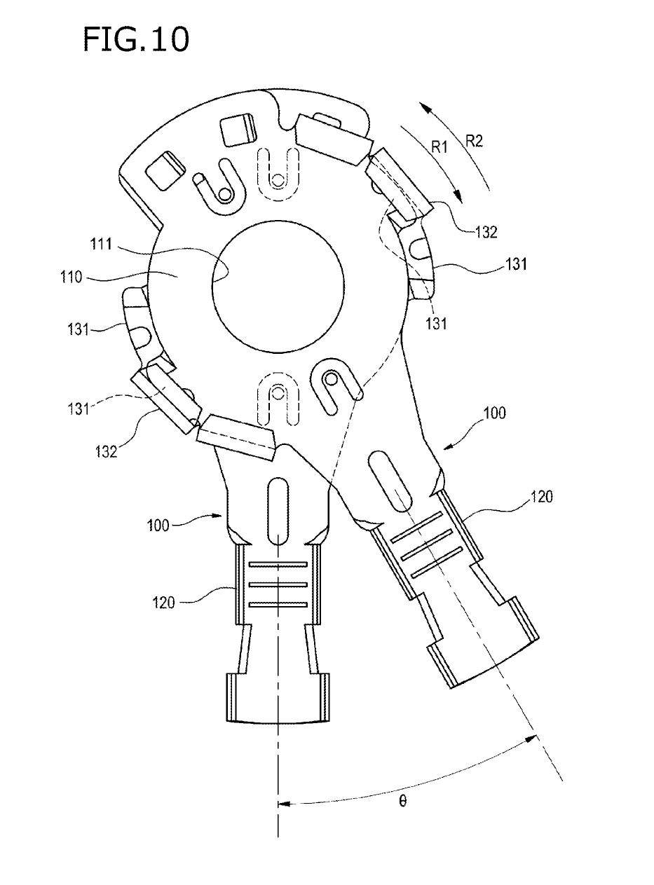

### DETAILED DESCRIPTION OF THE EXEMPLARY EMBODIMENTS

Preferred embodiments of a connection structure for terminal metal fittings according to the invention will be described below in detail with reference to the drawings.

### First Embodiment

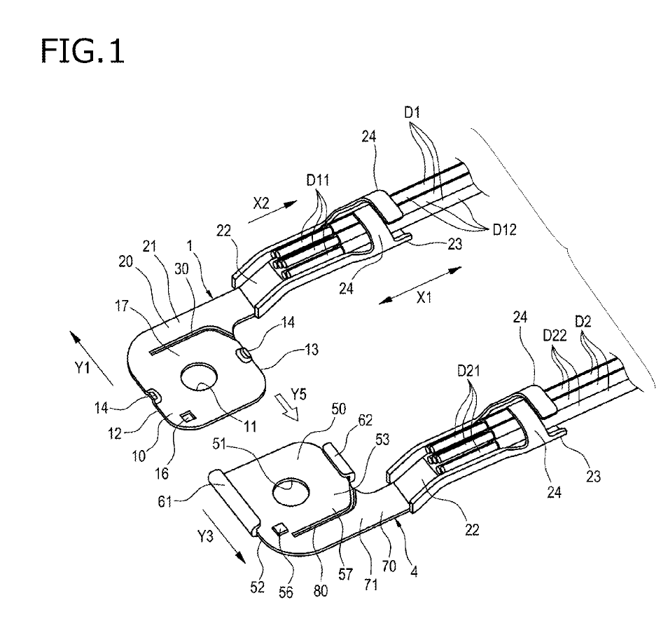

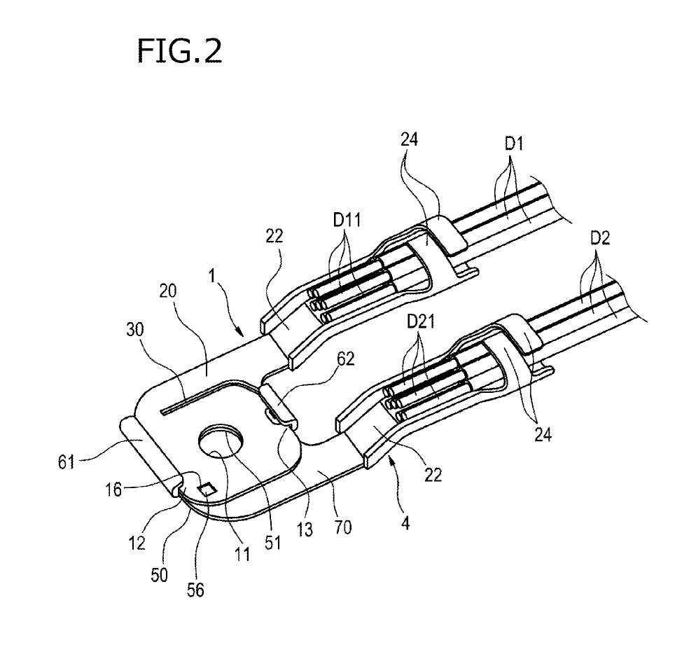

FIG. 1 and FIG. 2 show a first embodiment of a connection structure for terminal metal fittings according to the invention. FIG. 1 is a perspective view of a decoupling state of the connection structure for ground terminal metal fittings according to the first embodiment. FIG. 2 is a perspective view of a coupling state between a first ground terminal metal fitting and a second ground terminal metal fitting shown in FIG. 1.

The first ground terminal metal fitting 1 in the first embodiment is a press-molded article of a metal plate, which is used for electrically conductively connecting first ground electric wires (ground wires) D1 of an in-vehicle circuit (an accessory) to a ground surface of a vehicle body etc. The first ground terminal metal fitting 1 includes a first terminal body 10, a first electric wire connection portion 20, and a first breakage groove 30. The first terminal body 10 is shaped like a flat plate. The first electric wire connection portion 20 extends from the first terminal body 10. The first ground electric wires D1 are connected to the first electric wire connection portion 20. The first breakage groove 30 is disposed between the first terminal body 10 and the first electric wire connection portion 20.

A first mounting hole 11 shaped like a circle is provided in the center of the first terminal body 10. The first terminal body 10 is fixed to the ground surface of the vehicle body etc. by a bolt (not shown) which is inserted through the first mounting hole 11. Incidentally, the first mounting hole 11 may be provided not in the center but eccentrically.

In the case of the embodiment, the first terminal body 10 includes two straight sides 12 and 13 which are opposite to each other with respect to the first mounting hole 11. An arrow X1 in FIG. 1 designates an opposing direction of the two straight sides 12 and 13. The first terminal body 10 in the embodiment is shaped like a substantially tetragonal flat plate. The two opposite straight sides 12 and 13 are arranged in parallel with each other and perpendicularly to the arrow X1.

Bulging portions 14 are formed respectively in the two opposite straight sides 12 and 13 of the first terminal body 10 in the embodiment. When the two sides 12 and 13 are held by body holding portions 61 and 62 in a second ground terminal metal fitting 4 which will be described later, the bulging portions 14 make contact with inner side surfaces of the body holding portions 61 and 62 by a predetermined pressing force to thereby increase a coupling force performed by the body holding portions 61 and 62. A combinational structure for integrating the first ground terminal metal fitting 1 and the second ground terminal metal fitting 4 with each other in the invention includes the two straight sides 12 and 13, the bulging portions 14 and the body holding portions 61 and 62.

In addition, the first terminal body 10 in the embodiment has a positioning hole 16. When the first terminal body 10 is overlapped on a second terminal body 50 in the second ground terminal metal fitting 4 which will be described later by an insertion operation, the positioning hole 16 is engaged with a positioning protrusion 56 on the second terminal body 50. In this manner, the first terminal body 10 and the second terminal body 50 can be prevented from being misaligned from each other in a planar direction.

The first electric wire connection portion 20 in the embodiment is provided to be continued to an outer edge portion 17 of the first terminal body 10 which is located distantly in a direction of an arrow Y1 from the first mounting hole 11 of the first terminal body 10. The direction of the arrow Y1 is a direction perpendicular to the opposing direction (the direction of the arrow X1) of the two straight sides 12 and 13. In addition, the first electric wire connection portion 20 in the embodiment extends in the opposing direction (the direction of the arrow X1) of the two straight sides 12 and 13 to support the first ground electric wires D1 in the direction of the arrow X1.

In addition, the first electric wire connection portion 20 in the embodiment includes a first junction plate portion 21, a conductor connection portion 22, and a pair of caulking pieces 24. The first junction plate portion 21 is continued to the outer edge portion 17 of the first terminal body 10. The conductor connection portion 22 extends in a direction of an arrow X2 from the first junction plate portion 21. The pair of caulking pieces 24 are provided in a distal end plate portion 23 extending in the direction of the arrow X2 from the conductor connection portion 22.

The arrow X2 serving as the extension direction of the conductor connection portion 22 is a direction parallel with the arrow X1 but toward one side of the arrow X1. Accordingly, the conductor connection portion 22 extends in the opposing direction of the two straight sides 12 and 13.

The conductor connection portion 22 of the first electric wire connection portion 20 is a part to which conductor portions D11 of the first ground electric wires D1 fixed to the distal end plate portion 23 by the caulking pieces 24 which will be described later are electrically conductively connected by ultrasonic bonding, a bonder (thermal welding), crimping, etc. Accordingly, no caulking piece for crimping connection is required in the conductor connection portion 22, differently from that in a case where the conductor portions D11 are crimped and connected. Therefore, no irregularity is formed in a widthwise direction for the caulking pieces in the conductor connection portion 22 in the embodiment. Accordingly, the conductor connection portion 22 can be formed into a simply flat plate structure having no irregularity in the widthwise direction.

In the case of the first ground terminal metal fitting 1 in the embodiment, as soon as the conductor portions D11 of the ground electric wires D1 are connected to the conductor connection portion 22 by ultrasonic bonding, the bonder (thermal welding), crimping, etc., waterproof treatment and anticorrosion treatment are applied to the connection places of the conductor portions D11 to the conductor connection portion 22 in a lump.

Since the waterproof treatment and the anticorrosion treatment are applied to the conductor portions D11 in a lump, working efficiency can be improved greatly in comparison with that in a case where the waterproof treatment and the anticorrosion treatment are applied to each of the conductor portions D11 separately.

The pair of caulking pieces 24 of the first electric wire connection portion 20 are shaped like plate pieces which protrude from the distal end portion 23 on opposite widthwise (the direction perpendicular to the arrow X2) sides of the distal end portion 23. The distal end portion 23 extends in the direction of the arrow X2. Sheaths D12 of the first ground electric wires D1 are caulked by the pair of caulking pieces 24 to thereby fix the first ground electric wires D1 to the distal end plate portion 23.

For example, assume that a shearing force not lower than a predetermined value is applied to the first breakage groove 30 provided in the first ground terminal metal fitting 1, due to an external load acting on the first electric wire connection portion 20 from the first ground electric wires D1 fixed to the first electric wire connection portion 20. In this case, the first electric wire connection portion 20 is cut off from the first terminal body 10. A breaking load is set for the first breakage groove 30 in the embodiment so as not to generate breakage due to a load and vibration acting on the first ground electric wires D1 in a normal use state of the first ground electric wires D1 routed in the vehicle.

The first ground electric wires D1 connected to the first ground terminal metal fitting 1 in the embodiment are connected directly to a ground terminal of the accessory without any joint (also including any joint connector) used halfway. Thus, due to the use of the routing structure in which the first ground electric wires D1 are connected directly to the accessory without any joint (also including any joint connector) used halfway, noise resistance performance can be improved.

Incidentally, it is preferable that connection between the first ground electric wires D1 and an accessory-side connector is performed prior to connection between the first ground terminal metal fitting 1 and the first ground electric wires D1.

The second ground terminal metal fitting 4 in the first embodiment is a terminal metal fitting which can be coupled to the aforementioned first grounding terminal metal fitting 1 in a overlapped state.

The second ground terminal metal fitting 4 is a press-molded article of a metal plate, which is used for electrically conductively connecting second ground electric wires D2 of the in-vehicle circuit to the ground surface of the vehicle body etc. in the same manner as the first ground terminal metal fitting 1. The second ground terminal metal fitting 4 includes the second terminal body 50, a pair of body holding portions 61 and 62, a second electric wire connection portion 70, and a second breakage groove 80. The second terminal body 50 is shaped like a flat plate. The pair of body holding portions 61 and 62 couple the second terminal body 50 and the first terminal body 10 of the first ground terminal metal fitting 1 to each other. The second electric wire connection portion 70 extends from the second terminal body 5. The second ground electric wires D2 are connected to the second electric wire connection portion 70. The second breakage groove 80 is disposed between the second terminal body 50 and the second electric wire connection portion 70.

The second terminal body 50 is formed into a flat plate shape having substantially the same dimensions and shape as the first terminal body 10 of the first ground terminal metal fitting 1. That is, the second terminal body 50 is shaped like a substantially tetragonal flat plate. A second mounting hole 51 is formed in the center of the second terminal body 50 so that a bolt (not shown) can be inserted through the second mounting hole 51. The second mounting hole 51 made thus is formed with an inner diameter substantially the same as the first mounting hole 11 in the first ground terminal metal fitting 1. Incidentally, the second mounting hole 51 may be provided not in the center but eccentrically.

Incidentally, the second terminal body 50 has two straight sides 52 and 53 corresponding to the two straight sides 12 and 13 of the first terminal body 10. The two straight sides 52 and 53 in the second terminal body 50 are sides opposite to each other in the direction of the arrow X1 in FIG. 1 with respect to the second mounting hole 51. In addition, the positioning protrusion 56 is provided in the second terminal body 50. When the first terminal body 10 of the first ground terminal metal fitting 1 is put on top of the second terminal body 50, the positioning protrusion 56 is engaged with the positioning hole 16 on the first terminal body 10. In this manner, it is possible to prevent the first terminal body 10 and the second terminal body 50 from being misaligned from each other in the planar direction.

The pair of body holding portions 61 and 62 are provided to be continued to the two sides 52 and 53 of the second terminal body 50 corresponding to the two straight sides 12 and 13 of the first terminal body 10. Each of the body holding portions 61 and 62 extends in the direction perpendicular to the direction of the arrows X1 in FIG. 1.

The body holding portions 61 and 62 have grooves into which the two straight sides 12 and 13 of the first terminal body 10 can be inserted, respectively. When the first terminal body 10 is put on top of the second terminal body 50 by an insertion operation performed in a direction of an arrow Y3 perpendicular to the opposing direction (the direction of the arrow X1) of the two straight sides 12 and 13 of the first terminal body 10, the two straight sides 12 and 13 of the first terminal body 10 are held in the second terminal body 50 in the embodiment to thereby make a coupling state between the first terminal body 10 and the second terminal body 50.

The direction of the arrow Y3 shown in FIG. 1 is a direction which is perpendicular to the direction of the arrow X1 and opposite to the direction of the arrow Y1.

In addition, when the two straight sides 12 and 13 of the first terminal body 10 are inserted into the body holding portions 61 and 62, the positioning hole 16 on the first terminal body 10 is engaged with the positioning protrusion 56 on the second terminal body 50. In this manner, it is possible to prevent the first terminal body 10 and the second terminal body 50 from being misaligned from each other in the planar direction. Incidentally, the positioning hole 16 of the first terminal body 10 of the first ground terminal metal fitting 1 may be omitted. In this case, the positioning protrusion 56 of the second terminal body 50 of the second ground terminal metal fitting 4 may be used as an indent for electric conduction between the terminal bodies 10 and 50. Alternatively, the indent for electric conduction may be formed in the second terminal body 50 separately from the positioning protrusion 56.

The second electric wire connection portion 70 is provided to be continued to an outer edge portion 57 of the second terminal body 50 located distantly in the direction of the arrow Y3 from the second mounting hole 51 of the second terminal body 50. In addition, the second electric wire connection portion 70 in the embodiment extends outward in the direction of the arrow X2 in the same manner as the first electric wire connection portion 20 in the first ground terminal metal fitting 1 to support the second ground electric wires D2 in the direction of the arrow X2.

That is, the second electric wire connection portion 70 is provided in the outer edge portion 57 of the second terminal body 50 located on an opposite side to the first electric wire connection portion 20 with respect to the first mounting hole 11, to thereby support the second ground electric wires D2 in parallel with the electric wire leading-out direction in the first ground terminal metal fitting 1.

The specific configuration of the second electric wire connection portion 70 in the embodiment is common to the first electric wire connection portion 20 in the first ground terminal metal fitting 1. Common parts will be referred to by common signs respectively and description thereof will be made briefly. That is, the second electric wire connection portion 70 includes a junction plate portion 71, a conductor connection portion 22, and a pair of caulking pieces 24. The junction plate portion 71 is continued to the outer edge portion 57 of the second terminal body 50. The conductor connection portion 22 extends in the direction of the arrow X2 from the junction plate portion 71. The pair of caulking pieces 24 are provided in a distal end plate portion 23 which extends in the direction of the arrow X2 from the conductor connection portion 22. Conductor portions D21 of the second ground electric wires D2 are connected to the conductor connection portion 22 by ultrasonic bonding, a bonder (thermal welding), crimping, etc.

Incidentally, it is preferable that connection between the second ground electric wires D2 and an accessory-side connector is performed prior to connection between the second ground terminal metal fitting 4 and the second ground electric wires D2.

In addition, as soon as the conductor portions D21 of the second ground electric wires D2 are connected to the conductor connection portion 22 by ultrasonic bonding, the bonder (thermal welding), crimping, etc., waterproof treatment and anticorrosion treatment are applied to connection places of the conductor portions D21 to the conductor connection portion 22 in a lump.

The second breakage groove 80 in the second ground terminal metal fitting 4 corresponds to the first breakage groove 30 in the first ground terminal metal fitting 1. The second breakage groove 80 is provided between the second terminal body 50 and the second electric wire connection portion 70. When a shearing force not lower than a predetermined value is applied to the second breakage groove 80, the second electric wire connection portion 70 is cut off from the second terminal body 50.

The aforementioned first ground terminal metal fitting 1 and the aforementioned second ground terminal metal fitting 4 in the first embodiment can be also used exclusively. Therefore, planar surfaces wider than seat surfaces of the bolts (not shown) inserted through the mounting holes 11 and 51 of the terminal bodies 10 and 50 are secured in the peripheries of the mounting holes 11 and 51. In addition, lower surfaces of the terminal bodies 10 and 50 are formed as flat surfaces so that the first ground terminal metal fitting 1 and the second ground terminal metal fitting 4 can be used exclusively.

When the total number of the ground electric wires D1 or D2 is too large for exclusive use of the first ground terminal metal fitting 1 or the second ground terminal metal fitting 4, the total number of the ground electric wires D1 or D2 can be divided into two suitably and bundles of the divided ground electric wires D1 or D2 can be connected to the first ground terminal metal fitting 1 and the second ground terminal metal fitting 4 respectively. The first ground terminal metal fitting 1 and the second ground terminal metal fitting 4 to which the electric wires have been connected are put on top of each other and fastened to a ground portion with a bolt.

In addition, in the case where electric wires of different kinds of materials such as electric wires of copper and electric wires of aluminum (also including electric wires of an aluminum alloy) are used mixedly as the ground electric wires D1 and D2, the first ground terminal metal fitting 1 and the second ground terminal metal fitting 4 may be used separately based on the kinds of the electric wires.

For example, only the electric wires of copper may be connected to one of the first ground terminal metal fitting 1 and the second ground terminal metal fitting 4 while only the electric wires of aluminum are connected to the other ground terminal metal fitting.

According to such a configuration, only the electric wires of copper (including a copper alloy) are connected to the one ground terminal metal fitting. Accordingly, equipment or a work for connecting the ground terminal and the electric wires (for example, by ultrasonic bonding, the bonder (thermal welding) or crimping) to each other can be simplified. This is because it will go well as long as the electric wires of copper are taken into consideration in any setting value of the equipment etc. or during any work of connection. Only the other ground electric wires contain aluminum. Accordingly, it will go well as long as anticorrosion treatment etc. is applied only to connection portions between the other ground electric wires and the other terminal. The anticorrosion treatment etc. does not have to be performed on the ground electric wires of copper.

In addition, when the first ground terminal metal fitting 1 and the second ground terminal metal fitting 4 overlapped on each other are fastened and grounded to the vehicle body etc. with a bolt, a ground joint connector connected to another accessory may be fastened with the bolt. In this case, a ground terminal connection portion of the ground joint connector is formed with a structure in which a seat surface cannot be secured unless the first ground terminal metal fitting 1 and the second ground terminal metal fitting 4 are put on top of each other.

In addition, as shown in FIG. 1, the first ground terminal metal fitting 1 and the second ground terminal metal fitting 4 are disposed to be opposed to each other so that the ground electric wires D1 and D2 connected to the terminal metal fittings respectively can be in parallel with one another. In this state, an insertion operation is performed in a direction of an arrow Y5 to laminate the first terminal body 10 of the first ground terminal metal fitting 1 on the second terminal body 50 of the second ground terminal metal fitting 4. Then, as shown in FIG. 2, the two opposite straight sides 12 and 13 of the first terminal body 10 of the first ground terminal metal fitting 1 are held by the pair of body holding portions 61 and 62 of the second terminal body 50, so as to make a coupling state between the first terminal body 10 and the second terminal body 50. In the state in which the first terminal body 10 and the second terminal body 50 are coupled to each other, as shown in FIG. 2, the positioning protrusion 56 of the second terminal body 50 and the positioning hole 16 of the first terminal body 10 are engaged with each other, so that the second terminal body 50 and the first terminal body 10 can be restricted from moving relatively to each other in the insertion direction.

Assume that the aforementioned first ground terminal metal fitting 1 and the aforementioned second ground terminal metal fitting 4 are used exclusively. In this case, in order to recycle the ground electric wires D1 or D2 connected to the ground surface by the first ground terminal metal fitting 1 or the second ground terminal metal fitting 4, for example, the ground electric wires D1 or D2 are pulled in a direction perpendicular to the surface of the first terminal body 10 or the second terminal body 50 to apply a shearing force not lower than a predetermined value to the breakage groove 30 or 80 provided between the terminal body 10 or 50 and the electric wire connection portion 20 or 70. Then, the breakage groove 30 or 80 breaks so that the ground electric wires D1 or D2 can be cut off from the terminal body 10 or 50 and recycled easily. Accordingly, the ground electric wires D1 or D2 can be cut off from the ground surface easily during recycling so that the ground electric wires D1 or D2 can be recycled easily.

In addition, assume that electrically conductive connection of the conductor portions D11 or D21 of the ground electric wires D1 or D2 to the electric wire connection portion 20 or 70 is performed based on crimping connection which has been used widely in the background art. In this case, caulking pieces for fixing the electric wires with sheaths and conductor crimping caulking pieces for caulking the conductors of the electric wires are required to be provided in the electric wire connection portion 20 or 70 respectively. Therefore, the electric wire connection portion 20 or 70 may be formed into a complicated shape with lots of irregularities in a widthwise direction, causing deterioration in moldability.

However, electrically conductive connection of the conductor portions D11 and D21 of the ground electric wires D1 and D2 to the electric wire connection portions 20 and 70 in the first ground terminal metal fitting 1 and the second ground terminal metal fitting 4 in the embodiment is achieved by ultrasonic bonding, a bonder (thermal welding), crimping, etc. Accordingly, for example, the conductor crimping caulking pieces are not provided but a simply flat plate-like conductor connection portion 22 with no irregularity in the widthwise direction may be provided instead in each electric wire connection portion 20, 70. Accordingly, it is possible to form the electric wire connection portion 20, 70 into a simple shape with less irregularities in the widthwise direction so that it is possible to improve moldability.

In addition, in the case of the second ground terminal metal fitting 4 in the embodiment, the first terminal body 10 of the first ground terminal metal fitting 1 is inserted onto the second terminal body 50 of the second ground terminal metal fitting 4 in the direction perpendicular to the opposing direction of the two straight sides 12 and 13 of the first terminal body 10 so that the first terminal body 10 can be put on top of the second terminal body 50. In this manner, the two opposite straight sides 12 and 13 of the first terminal body 10 are held by the pair of body holding portions 61 and 62 on the second terminal body 50, and the first terminal body 10 is overlapped on the second terminal body 50. In this state, the first ground terminal metal fitting 1 and the second ground terminal metal fitting 4 are coupled to each other.

That is, the second ground terminal metal fitting 4 can be coupled to the first ground terminal metal fitting 1 easily by an insertion operation performed from the side of the first ground terminal metal fitting 1.

Since the first ground terminal metal fitting 1 and the second ground terminal metal fitting 4 are coupled to each other, it is possible to increase the number of the ground electric wires D1 or D2 which can be connected, and it is possible to deal with an increase of the number of the ground electric wires D1 or D2 easily.

In addition, the ground electric wires D2 connected to the second ground terminal metal fitting 4 and the ground electric wires D1 connected to the first ground terminal metal fitting 1 are led out in parallel with one another from the terminal metal fittings 1 and 4 respectively. Therefore, a large number of ground electric wires D1 or D2 can be tied up into one bundle and routed easily, and it is also possible to route the large number of ground electric wires D1 or D2 compactly.

In addition, in the embodiment, the second breakage groove 80 for cutting off the second electric wire connection portion 70 from the second terminal body 50 is also provided in the second ground terminal metal fitting 4. Therefore, the second ground electric wires D2 connected to the second ground terminal metal fitting 4 can be cut off from the second terminal body 50 and recycled easily in the same manner as the first ground terminal metal fitting 1. Accordingly, the large numbers of ground electric wires D1 and D2 connected to the first ground terminal metal fitting 1 and the second ground terminal metal fitting 4 can be cut off from the ground surface easily during recycling. Thus, the ground electric wires D1 and D2 can be recycled easily.

In addition, in the case of the embodiment, the first terminal body 10 of the first ground terminal metal fitting 1 and the second terminal body 50 of the second ground terminal metal fitting 4 which are overlapped on each other are coupled to each other when the two opposite straight sides 12 and 13 are held. Simultaneously with the coupling, the first ground terminal metal fitting 1 and the second ground terminal metal fitting 4 are restricted from moving relatively to each other. Therefore, a special structure for restricting the terminal metal fittings from rotating relatively to each other is not necessarily provided in the first ground terminal metal fitting 1 or the second ground terminal metal fitting 4. Thus, it is also possible to simplify the structures of the respective terminal metal fittings.

In addition, the configurations of the conductor connection portions 22 in the first ground terminal metal fitting 1 and the second ground terminal metal fitting 4 are identical with each other, and connection methods (ultrasonic bonding, a bonder (thermal welding), crimping, etc.) for the conductor connection portions 22 are also identical with each other. Accordingly, a conductor connection device can be shared between the first ground terminal metal fitting 1 and the second ground terminal metal fitting 4.

In addition, it is preferable that a work for connecting the ground electric wires D1 and D2 to the accessory-side connectors is performed prior to a work for connecting the first ground terminal metal fitting 1 and the second ground terminal metal fitting 4 to the ground electric wires D1 and D2. In this case, after the connection to the accessory is completed, the ground electric wires D1 and D2 are connected to the first ground terminal metal fitting 1 and the second ground terminal metal fitting 4 respectively in a wire harness manufacturing line in which a terminal connection device is installed.

The work for connecting the ground electric wires D1 and D2 to the accessory-side connectors is performed prior to the work for connecting the first ground terminal metal fitting 1 and the second ground terminal metal fitting 4 to the ground electric wires D1 and D2. Accordingly, it is possible to improve the quality of a wire harness, and it is easy to produce the wire harness.

Incidentally, the first ground electric wires D1 and the second ground electric wires D2 may include drain wires for shield electric wires. According to such a configuration, the drain wires connected to shield layers of the shield wires may be also grounded in the same manner.

Here, the wire harness can be manufactured, for example, in the following steps.

### Inline Work Steps

Cut off electric wires→peel sheaths of electric wires and crimp peeled electric wires to terminals→connect terminals to accessory-side connectors (beforehand fitting)→route electric wires and connect ground terminals→apply waterproof and anticorrosion treatment→apply exterior finish→inspect electric conduction

### Offline Work Steps

Cut off electric wires→peel sheaths of electric wires and crimp peeled electric wires to terminals→connect terminals to accessory-side connectors (beforehand fitting)→route electric wires→cut off electric wires→peel sheaths of electric wires→connect ground terminals→apply waterproof and anticorrosion treatment→apply exterior finish→inspect electric conduction

Incidentally, the embodiment has been described along an example in which the connection structure for terminals according to the invention is applied to the connection structure for the first ground terminal metal fitting 1 and the second ground terminal metal fitting 4 to electrically conductively connect the ground electric wires from the accessory to the ground surface. However, the connection structure for terminals according to the invention may be applied to a connection structure for terminal metal fittings to electrically conductively connect the terminal metal fittings to a terminal (mating terminal connection portion) belonging to a power supply.

In this case, the first ground terminal metal fitting 1 and the second ground terminal metal fitting 4 shown in FIG. 1 and FIG. 2 are used as a first power supply-side terminal metal fitting and a second power supply-side terminal metal fitting respectively. The first power supply-side terminal metal fitting and the second power supply-side terminal metal fitting are coupled to each other as shown in FIG. 2 and connected to the terminal (mating terminal connection portion) belonging to the power supply, or either the first power supply-side terminal metal fitting or the second power supply-side terminal metal fitting is connected thereto exclusively.

In addition, the first ground terminal metal fitting and the second ground terminal metal fitting can be applied to the first power supply-side terminal metal fitting and the second power supply-side terminal metal fitting also in the second to fourth embodiments which will be described below.

### Second Embodiment

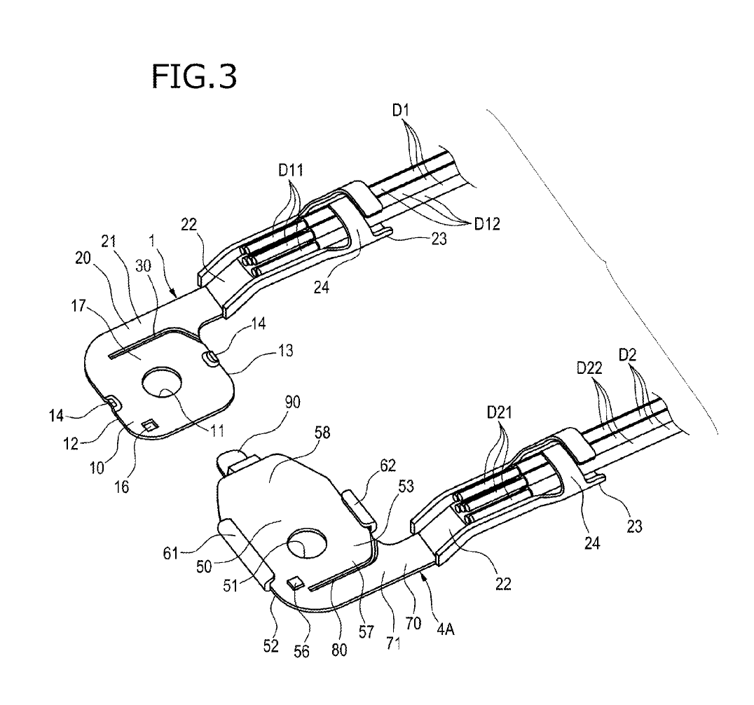

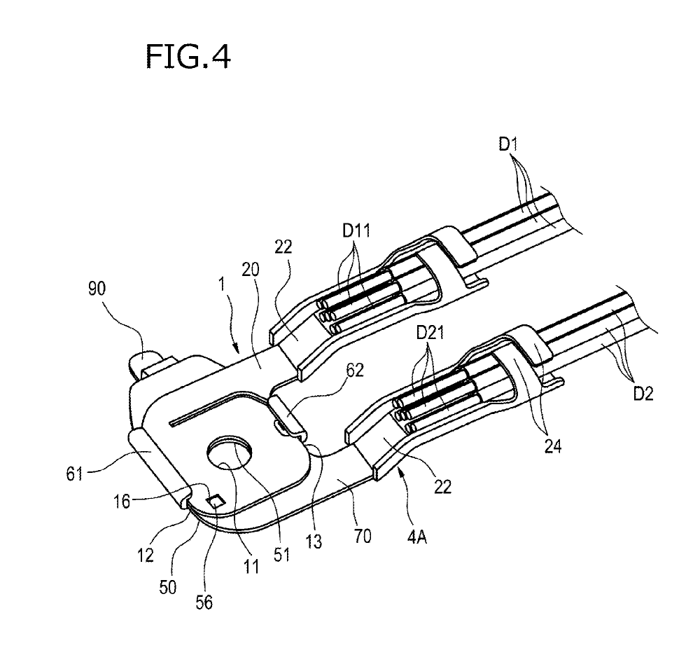

FIG. 3 and FIG. 4 show a second embodiment of the connection structure for terminal metal fittings according to the invention. FIG. 3 is a perspective view of a decoupling state of the second embodiment of the connection structure for ground terminal metal fittings. FIG. 4 is a perspective view of a state in which a first ground terminal metal fitting and a second ground terminal metal fitting shown in FIG. 3 are coupled to each other.

In the second embodiment, a first ground terminal metal fitting 1 shown in the first embodiment is combined with a second ground terminal metal fitting 4A formed as a partial improvement of the second ground terminal metal fitting 4 in the first embodiment.

In the second ground terminal metal fitting 4A, a rotation stopping piece 90 is provided in an outer edge portion 58 of a second terminal body 50 shown in the first embodiment.

The outer edge portion 58 of the second terminal body 50 provided with the rotation stopping piece 90 is positioned on an opposite side to an outer edge portion 57 with respect to a second mounting hole 51. A second electric wire connection portion 70 is continued to the outer edge portion 57.

The rotation stopping piece 90 is a bent portion which can be engaged with a step in the periphery of a ground surface where the first ground terminal metal fitting 1 and the second ground terminal metal fitting 4A are fastened to each other with a bolt. Due to the rotation stopping piece 90 which is engaged with the step in the periphery of the ground surface, the second terminal body 50 is restricted from rotating relatively to the ground surface.

The second ground terminal metal fitting 4A according to the embodiment may have a common configuration to the second ground terminal metal fitting 4 in the first embodiment, except the point that the rotation stopping piece 90 is added. Common constituents will be referred to by the same signs respectively and description thereof will be omitted.

In the case of the embodiment, assume that the first ground terminal metal fitting 1 which has been coupled to the second ground terminal metal fitting 4A is fastened to the ground surface with a bolt. In this case, the rotation stopping piece 90 provided in the second ground terminal metal fitting 4A restricts the relative rotation to the ground surface. Accordingly, it is unnecessary to press the respective terminal metal fittings to prevent the terminal metal fittings from rotating relatively to the ground surface during a bolt fastening work, and it is possible to easily perform a work for fixing the terminal metal fittings to the ground surface.

In addition, the same rule is also applied to the case where the second ground terminal metal fitting 4A having the rotation stopping piece 90 is used exclusively.

### Third Embodiment

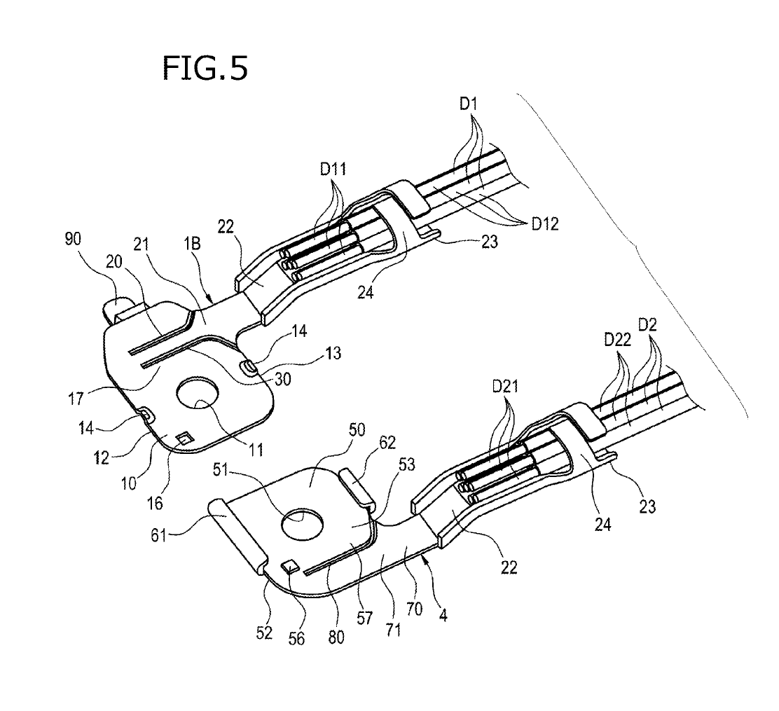

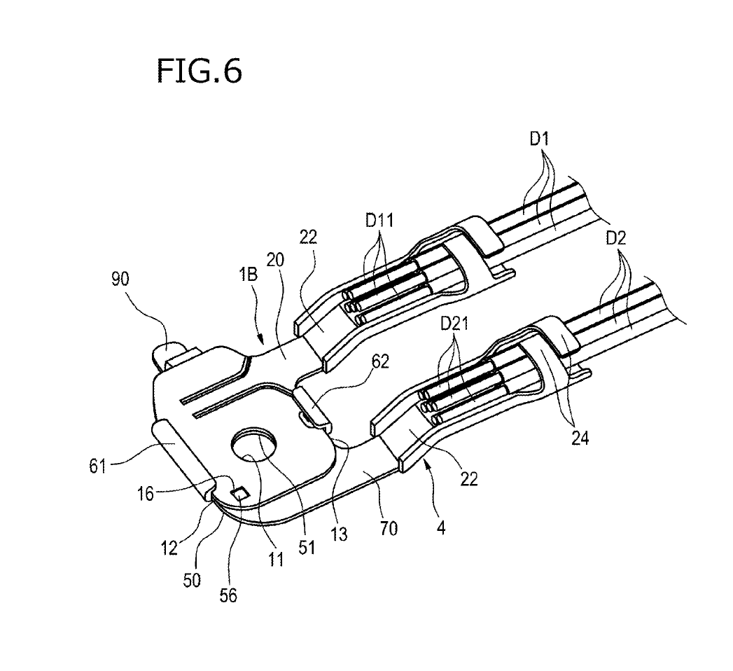

FIG. 5 and FIG. 6 show a third embodiment of the connection structure for terminal metal fittings according to the invention. FIG. 5 is a perspective view of a decoupling state of the third embodiment of the connection structure for ground terminal metal fittings. FIG. 6 is a perspective view of a state in which a first ground terminal metal fitting and a second ground terminal metal fitting shown in FIG. 5 are coupled to each other.

In the third embodiment, a second ground terminal metal fitting 4 shown in the first embodiment is combined with a first ground terminal metal fitting 1B formed as a partial improvement of the first ground terminal metal fitting 1 in the first embodiment.

In the first ground terminal metal fitting 1B, a rotation stopping piece 90 is provided in an outer edge portion 17 of a first terminal body 10 shown in the first embodiment. The rotation stopping piece 90 is provided to be positioned on an outer side of a first electric wire connection portion 20 which is likewise provided consecutively to the outer edge portion 17.

The rotation stopping piece 90 is a bent portion which can be engaged with a step in the periphery of a ground surface where the first ground terminal metal fitting 1B and the second ground terminal metal fitting 4 are fastened to each other with a bolt. Due to the rotation stopping piece 90 which is engaged with the step in the periphery of the ground surface, the first terminal body 10 is restricted from rotating relatively to the ground surface.

The first ground terminal metal fitting 1B in the embodiment may have a common configuration to the first ground terminal metal fitting 1 in the first embodiment, except that the rotation stopping piece 90 is added. Common constituents will be referred to by the same signs respectively and description thereof will be omitted.

In the case of the embodiment, assume that the first ground terminal metal fitting 1B which has been coupled to the second ground terminal metal fitting 4 is fastened to the ground surface with a bolt or that the first ground terminal metal fitting 1B is fastened to the ground surface with a bolt exclusively. In this case, the rotation stopping piece 90 provided in the first ground terminal metal fitting 1B restricts the relative rotation to the ground surface. Accordingly, it is unnecessary to press the terminal metal fittings to prevent the terminal metal fittings from rotating relatively to the ground surface during a bolt fastening work, and it is possible to easily perform a work for fixing these terminal metal fittings to the ground surface.

In addition, the same rule is also applied to the case where the first ground terminal metal fitting 1B having the rotation stopping piece 90 is used exclusively.

### Fourth Embodiment

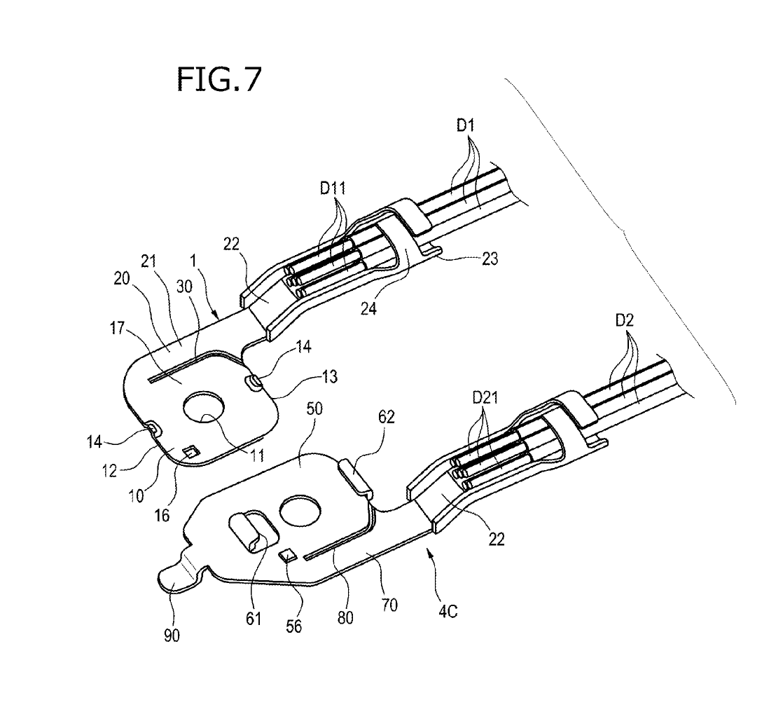

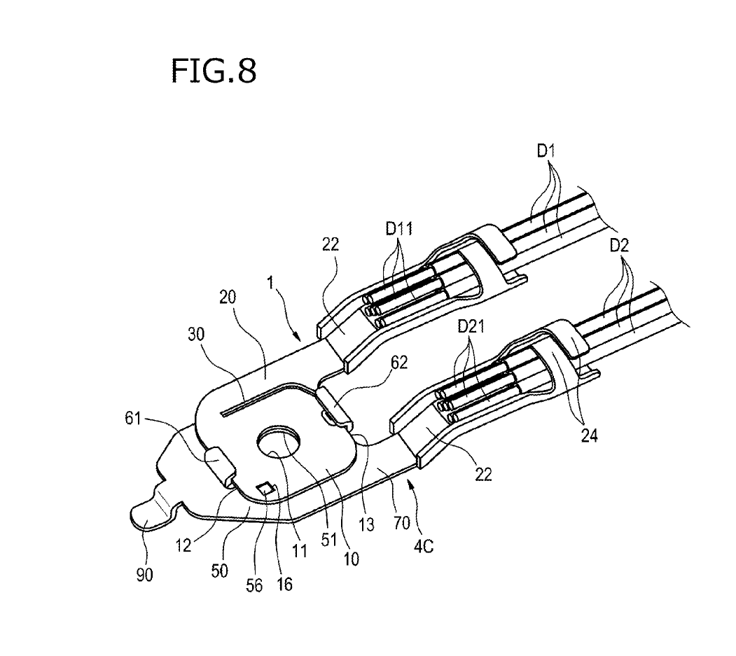

FIG. 7 and FIG. 8 show a fourth embodiment of the connection structure for terminal metal fittings according to the invention. FIG. 7 is a perspective view of a decoupling state of the fourth embodiment of the connection structure for ground terminal metal fittings. FIG. 8 is a perspective view of a state in which a first ground terminal metal fitting and a second ground terminal metal fitting shown in FIG. 7 are coupled to each other.

In the fourth embodiment, a first ground terminal metal fitting 1 shown in the first embodiment is combined with a second ground terminal metal fitting 4C formed as a partial improvement of the second ground terminal metal fitting 4 in the first embodiment.

The second ground terminal metal fitting 4C includes a rotation stopping piece 90 on a further outer side of a body holding portion 61 provided in an outer edge portion of a second terminal body 50 shown in the first embodiment.

The rotation stopping piece 90 is a bent portion which can be engaged with a step in the periphery of a ground surface where the first ground terminal metal fitting 1 and the second ground terminal metal fitting 4C are fastened to each other with a bolt. Due to the rotation stopping piece 90 which is engaged with the step in the periphery of the ground surface, the second terminal body 50 is restricted from rotating relatively to the ground surface.

The second ground terminal metal fitting 4C in the embodiment may have a common configuration to the second ground terminal metal fitting 4 in the first embodiment, except that the rotation stopping piece 90 is added. Common constituents will be referred to by the same signs respectively and description thereof will be omitted.

Also in the case of the embodiment, assume that the first ground terminal metal fitting 1 which has been coupled to the second ground terminal metal fitting 4C is fastened to the ground surface with a bolt. In this case, the rotation stopping piece 90 provided in the second ground terminal metal fitting 4C restricts the rotation relative to the ground surface. Accordingly, it is unnecessary to press the terminal metal fittings to prevent the terminal metal fittings from rotating relatively to the ground surface during a bolt fastening work, and it is possible to easily perform a work for fixing these terminal metal fittings to the ground surface.

In addition, the same rule is also applied to the case where the second ground terminal metal fitting 4C having the rotation stopping piece 90 is used exclusively.

Incidentally, the invention is not limited to the aforementioned embodiments but may be carried out with modification, improvement, etc. made thereon suitably. In addition thereto, the materials, the shapes, the dimensions, the numbers, the arrangement places etc. of the respective constituent elements in the aforementioned embodiments are not limited but may be set desirably as long as the invention can be achieved.

For example, each of the shape of the first terminal body in the first terminal metal fitting and the shape of the second terminal body in the second terminal metal fitting in the invention is not limited to a square shape or a rectangular shape shown in any of the aforementioned embodiments. For example, the shape of the first terminal body or the second terminal body can be set variously. For example, the shape of the first terminal body or the second terminal body can be a triangular shape, an elliptical shape, a polygonal shape which is at least a pentagonal shape, etc.

In addition, the first terminal body 10 in the first ground terminal metal fitting 1 or 1B may have a shape having two curved or arc-like sides by which the two straight sides 12 and 13 are replaced.

In addition, electrically conductive connection of the conductor portions of the ground electric wires to the first terminal metal fitting and the second terminal metal fitting in the invention may be performed by a crimping method using caulking pieces which have been used widely in the background art.

Here, the aforementioned characteristics of the embodiments of the connection structure for terminal metal fittings according to the invention will be summarized briefly in the following [1] to [7] respectively.
[1] A connection structure for terminal metal fittings, including:

a first terminal metal fitting (first ground terminal metal fitting 1) to which a plurality of first electric wires (ground electric wires D1) are connected; and

a second terminal metal fitting (second ground terminal metal fitting 4) to which a plurality of second electric wires (ground electric wires D2) are connected,

wherein one of the first terminal metal fitting (first ground terminal metal fitting 1) and the second terminal metal fitting (second ground terminal metal fitting 4) is enable a connection and a fixation to a mating terminal connection portion or a ground portion exclusively;

wherein the first terminal metal fitting (first ground terminal metal fitting 1) and the second terminal metal fitting (second ground terminal metal fitting 4) are combined with each other and then connected and fixed to the mating terminal connection portion or the ground portion.
[2] The connection structure for the terminal metal fittings according to the aforementioned [1], wherein the first electric wires (ground electric wires D1) and the second electric wires (ground electric wires D2) are consist of electric wires of copper (including a copper alloy), electric wires of aluminum (including an aluminum alloy), or a mixture of electric wires of copper (including a copper alloy) and electric wires of aluminum (including an aluminum alloy).
[3] The connection structure for the terminal metal fittings according to the aforementioned [1], wherein one of the first electric wires (ground electric wires D1) and the second electric wires (ground electric wires D2) are consist of electric wires of copper (including a copper alloy); and

wherein the other of the first electric wires (ground electric wires D1) and the second electric wires (ground electric wires D2) are consist of electric wires of aluminum (including an aluminum alloy) or a mixture of electric wires of copper (including a copper alloy) and electric wires of aluminum (including an aluminum alloy).
[4] The connection structure for the terminal metal fittings according to any of the aforementioned [1] to [3], wherein the first electric wires (ground electric wires D1) and the second electric wires (ground electric wires D2) include drain wires for shield electric wires.
[5] The connection structure for the terminal metal fittings according to any of the aforementioned [1] to [4], wherein the first terminal metal fitting (first ground terminal metal fitting 1) includes a first terminal body (10) having a flat portion;

wherein the second terminal metal fitting (second ground terminal metal fitting 4) includes a second terminal body (50) having a flat portion; and

wherein the first terminal metal fitting (first ground terminal metal fitting 1) and the second terminal metal fitting (second ground terminal metal fitting 4) include a combinational structure configured to integrate the first and second terminal fittings with each other.
[6] The connection structure for the terminal metal fittings according to any of the aforementioned [1] to [5], wherein the first terminal metal fitting (first ground terminal metal fitting 1) include:

the first terminal body (10) which is shaped like a flat plate with a mounting hole (11); and

a first electric wire connection portion (20) to which the plurality of first electric wires (ground electric wires D1) are connected;

wherein the first terminal body (10) has two sides (12, 13) opposite to each other with respect to the mounting hole (11);

wherein the first electric wire connection portion (20) extends in an opposing direction of the two sides (12, 13) from an outer edge portion (17) of the first terminal body (10) located distantly from the mounting hole (11) in a direction perpendicular to the opposing direction of the two sides (12, 13), and supports the first electric wires (ground electric wires D1) in the opposing direction of the two sides (12, 13);

wherein the second terminal metal fitting (second ground terminal metal fitting 4) includes:

the second terminal body (50) which is formed into a flat plate shape having substantially the same dimensions and shape as the first terminal body (10) so that the second terminal body (50) can be overlapped on the first terminal body (10);

a pair of body holding pieces (61, 62) which are provided consecutively to two sides (52, 53) of the second terminal body (50) corresponding to the two sides (12, 13) of the first terminal body (10) so that when an insertion operation is performed in the direction perpendicular to the opposing direction of the two sides (12, 13) of the first terminal body (10) to put the first terminal body (10) on top of the second terminal body (50), the body holding portions (62, 63) is enable to hold the two sides (12, 13) of the first terminal body (10) to thereby make a coupling state between the first terminal body (10) and the second terminal body (50); and

a second electric wire connection portion (70) to which the plurality of second electric wires (ground electric wires D2) are connected;

the second electric wire connection portion (70) is provided in an outer edge portion (57) of the second terminal body (50) located on an opposite side to the first electric wire connection portion (20) of the first terminal metal fitting (first ground terminal metal fitting 1) with respect to the mounting hole (11), and supports the plurality of second electric wires (ground electric wires D2) in parallel with an electric wire leading-out direction in the first terminal metal fitting (first ground terminal metal fitting 1); and

the first terminal metal fitting (first ground terminal metal fitting 1) and the second terminal metal fitting (second ground terminal metal fitting 4) are overlapped on each other and then connected and fixed to the mating terminal connection portion or the ground portion.
7] The connection structure for the terminal metal fittings according to the aforementioned [5] or [6], wherein a rotation stopping piece (90) is provided on one of the first terminal body (10) and the second terminal body (50), the rotation stopping piece (90) being engaged with a step in the periphery of the ground surface to thereby restrict the two terminal bodies from rotating relatively to the ground surface.

Although the invention has been described in detail and with reference to the specific embodiments, it is obvious to those skilled in the art that various changes or modifications may be made on the invention without departing from the spirit and scope of the invention.

According to the invention, the first and second terminal metal fittings are combined with each other. In this manner, the invention can attain an effect that it is possible to deal with an increase of the number of electric wires easily and it is possible to route electric wires compactly. The invention which can attain the effect is useful for The connection structure for the terminal metal fittings.

What is claimed is:

1. A connection structure for terminal metal fittings, comprising:
a first terminal metal fitting to which a plurality of first electric wires are connected; and
a second terminal metal fitting to which a plurality of second electric wires are connected,
wherein one of the first terminal metal fitting and the second terminal metal fitting is enable a connection and a fixation to a mating terminal connection portion or a ground portion exclusively;
wherein the first terminal metal fitting and the second terminal metal fitting are combined with each other and then connected and fixed to the mating terminal connection portion or the ground portion.

2. The connection structure for terminal metal fittings according to claim 1, wherein the first electric wires and the second electric wires are consist of electric wires of copper (including a copper alloy), electric wires of aluminum (including an aluminum alloy), or a mixture of electric wires of copper (including a copper alloy) and electric wires of aluminum (including an aluminum alloy).

3. The connection structure for terminal metal fittings according to claim 1, wherein one of the first electric wires and the second electric wires are consist of electric wires of copper (including a copper alloy); and
wherein the other of the first electric wires and the second electric wires are consist of electric wires of aluminum (including an aluminum alloy) or a mixture of electric wires of copper (including a copper alloy) and electric wires of aluminum (including an aluminum alloy).

4. The connection structure for terminal metal fittings according to claim 1, wherein the first electric wires and the second electric wires include drain wires for shield electric wires.

5. The connection structure for terminal metal fittings according to claim 1, wherein the first terminal metal fitting includes a first terminal body having a flat portion;
wherein the second terminal metal fitting includes a second terminal body having a flat portion; and
wherein the first terminal metal fitting and the second terminal metal fitting include a combinational structure configured to integrate the first and second terminal metal fittings with each other.

6. The connection structure for terminal metal fittings according to claim 5, wherein the first terminal metal fitting includes:
the first terminal body which is shaped like a flat plate with a mounting hole; and
a first electric wire connection portion to which the plurality of first electric wires are connected;
wherein the first terminal body has two sides opposite to each other with respect to the mounting hole;
wherein the first electric wire connection portion extends in an opposing direction of the two sides from an outer edge portion of the first terminal body located distantly from the mounting hole in a direction perpendicular to the opposing direction of the two sides, and supports the first electric wires in the opposing direction of the two sides;
wherein the second terminal metal fitting includes;
the second terminal body which is formed into a flat plate shape having substantially the same dimensions and shape as the first terminal body so that the second terminal body can be overlapped on the first terminal body;
a pair of body holding pieces which are provided consecutively to two sides of the second terminal body corresponding to the two sides of the first terminal body so that when an insertion operation is performed in the direction perpendicular to the opposing direction of the two sides of the first terminal body to put the first terminal body on top of the second terminal body, the body holding portions is enable to hold the two sides of the first terminal body to thereby make a coupling state between the first terminal body and the second terminal body; and
a second electric wire connection portion to which the plurality of second electric wires are connected;
wherein the second electric wire connection portion is provided in an outer edge portion of the second terminal body located on an opposite side to the first electric wire connection portion of the first terminal metal fitting with respect to the mounting hole, and supports the plurality of second electric wires in parallel with an electric wire leading-out direction in the first terminal metal fitting; and
wherein the first terminal metal fitting and the second terminal metal fitting are overlapped on each other and then connected and fixed to the mating terminal connection portion or the ground portion.

7. The connection structure for terminal metal fittings according to claim 5, wherein a rotation stopping piece is provided on one of the first terminal body and the second terminal body, the rotation stopping piece being engaged with a step in the periphery of the ground portion to thereby restrict the two terminal bodies from rotating relatively to the ground portion.
